(19) United States
(12) Patent Application Publication
(10) Pub. No.: US 2011/0029479 A1
(43) Pub. Date: Feb. 3, 2011

(54) METHOD AND SYSTEM TO MAINTAIN SERVICE ARCHITECTURE REPOSITORIES

(76) Inventors: Miroslav Novak, Prague (CZ); Jan Simon, Prague (CZ); Jan Trcka, Revnice (CZ)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,693

(22) Filed: Jul. 31, 2009

(51) Int. Cl. G06F 17/30

(52) U.S. Cl. 707/610; 707/E17.01

(57) ABSTRACT

A method and system of maintaining a computing services repository, including: accessing service data stored in a configuration database to populate a services repository with services and the service data from the configuration database; performing on-going service discovery to synchronize the services depository and the configuration database; and managing service data imported to the services repository from the configuration database.

### BACKGROUND

A computer network is generally a group of interconnected computers and other devices, such as printers, external hard drives, modems, hubs, switches, bridges, routers, and so on. The network facilitates the computers to communicate with each other and also typically with external networks, such as the Internet. Networks may be classified according to a wide variety of characteristics, such as the hardware and software technology used to interconnect the individual devices in the network. A data center or datacenter, which may also be called a server farm, server room(s), and the like, may include and/or serve computer networks. A purpose of a datacenter or computer network may be running software applications or services that handle business and operational data of an organization or other entities. Further, a datacenter may have numerous applications to monitor the operations of the systems that make up the datacenter.

### BRIEF DESCRIPTION OF THE DRAWINGS

Certain exemplary embodiments are described in the following detailed description and in reference to the drawings, in which:

FIG. 1 is a diagrammatical representation of computer network system in accordance with an exemplary embodiment of the present invention;

FIG. 2 is a method of maintaining a repository in accordance with an exemplary embodiment of the present invention;

FIG. 3 is a diagrammatical representation of maintaining a repository in accordance with an exemplary embodiment of the present invention; and

FIG. 4 is a diagrammatical representation of memory coupled with a processor, the memory having computer-executable code stored thereon for maintaining a repository in accordance with an exemplary embodiment of the present invention.

### DETAILED DESCRIPTION OF SPECIFIC EMBODIMENTS

In a network or datacenter, Service Oriented Architectures (SOAs) may be used to build applications from software services. In certain examples, services may include intrinsically unassociated, loosely coupled units of functionality. These services may not have calls to each other embedded in them and, thus, each service may implement only one action. Instead of services embedding calls to each other in their source code, they may define protocols that describe how the services can interact with each other. A software developer, software engineer, or business process expert may associate individual SOA objects by using a technique termed orchestration. For example, in orchestration a software engineer or process engineer may associate relatively large amounts of software functionality (services) in a non-hierarchical arrangement (in contrast to a class hierarchy). This may be performed by using a software tool, for example, that contains a list of all of the services, their characteristics, and which has the ability to record both the designer's options and choices. Further, the tool may record the services that the software system can consume and use at run-time.

In a standalone-context for a business domain, SOA may provide a set of principles for governing concepts and changes while providing for realization of the phases of system development and integration. This architecture, when fulfilled, may package functionality as interoperable services. Such a system architected and developed may be labeled a SOA infrastructure or Service Oriented platform. The service oriented platform may facilitate the exchange of data between different applications and provide a loose coupling of services with operating systems, programming languages, and other technologies that underlie applications. Generally, SOA separates functions into distinct units, or services, which developers make accessible over a network in order that users can combine and reuse in the production of applications. These services may communicate with each other by passing data from one service to another or by coordinating an activity between two or more services, and so on. SOA can be realized in a continuum, from concepts of distributed computing and modular programming, through to practices of mashups (i.e., a webpage or application that combines data or functionality from two or more sources), Software as a Service (Saas), Cloud Computing, and the like.

Further, as should be apparent, SOA Repositories are generally part of a successful SOA. Therefore, it is typically beneficial to maintain accurate data in SOA Repositories. For example, governance features of SOA Repositories, such as lifecycle management, contract management, and the like, are less applicable if the underpinning data is inaccurate. While certain approaches, such as reviews, data staleness detection, and so on, can improve the quality of data, these processes are generally not automated, should be performed repeatedly, and can be costly. Moreover, as more companies control their information technology (IT) operations according to standards and best practices, such as per the Information Technology Infrastructure Library (ITIL®), Configuration Management Databases (CMDBs) are becoming ubiquitous.

Conventional approaches to ITILs and CMDBs may have various beneficial side-effects of their runtime enforcement/monitoring and Universal Description Discovery and Integration (UDDI) registry integration. However, these approaches may have limitations. For example, they may fail to account for IT operations metadata, which may provide additional valuable information about deployed services. Further, systems maintained by IT operations may generally not be considered because of their storage in CMDBs instead of UDDI registries. The conventional approaches may also provide limited discovery methods, as typically only monitored or managed services and their related metadata may be discovered. Thus, the conventional approaches generally do not provide or support extensible mechanisms whose purpose would be to discover deployed services without deploying special workflow or processes and provide no special workflow for harmonization of discovered services.

In contrast to the conventional approaches, exemplary embodiments of the present invention define, design, and implement a technique to semi-automatically or automatically harmonize data between repositories such as SOA Repositories and databases such as CMDBs. Certain implementations of CMDBs, such as the Hewlett Packard (HP) Universal CMDB, support auto-discovery mechanisms, may facilitate synchronization of CMDBs with associated systems. Further, web service standards, such as Web Service Definition Language (WSDL), may facilitate identification of web services automatically. Exemplary embodiments of the present invention automatically compare and update data of SOA Repositories with real data tracked by CMDBs.

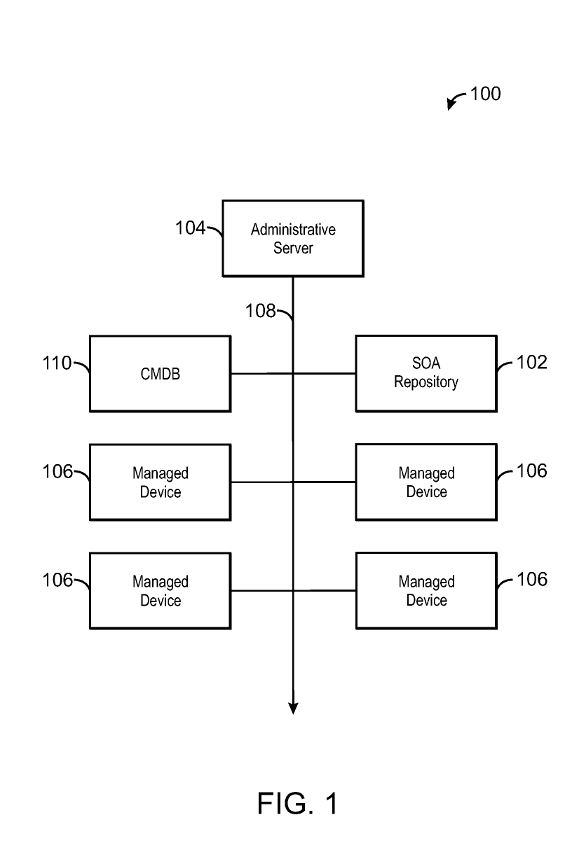

FIG. 1 is a computer network system 100 that may maintain a SOA repository 102 in accordance with an exemplary embodiment of the present invention. An administrative server 104 or managed device 106 (for example, a computer, laptop, server, etc.) may store all or various components of a system for maintaining a SOA repository 102 in memory. In exemplary embodiments, the SOA repository 102 may not be on a separate unit, but may, instead, be maintained within the administrative server 104. The managed devices 106 may be coupled to each other and other units by a network backbone 108. A configuration management database 110 may also be coupled to the network backbone 108. Data and information regarding the services and techniques may be stored in memory devices in the server 104 or in the managed devices 106 in the network system 100. The server 104 and managed devices 106 may provide a user interface (for example, display monitor, keyboard, mouse, etc.) to facilitate the implementation of the present techniques by a user. It should be noted that the managed devices 106 may also include printers, scanners, and other peripherals. Moreover, as can be appreciated, the server 104 and managed devices 106 may provide the computational power, such as a processor, to facilitate the various functions of managing a repository. Lastly, it should be noted that the system 100 can be more complex than depicted, such as having sub branches with additional devices, connections to an external network such as the Internet, and so on. Further, the system 100 could be, for example, a user or provider system, a datacenter, and so forth.

An SOA repository 102 is generally a database containing the software and metadata that constitute an SOA registry. The registry may be an evolving, interactive, controlled-access catalog that assists the management of SOA projects, facilitating businesses and organizations to discover and communicate with each other using Web services, for example. Typically, as a metadata repository, the SOA repository 102 facilitates content validation and workflow support for the SOA. The repository 102 may be a medium of record for policies, processes, attributes and schemata related to SOA governance. In some publications and contexts, the repository and the registry are treated as a single entity called the SOA registry-repository or SOA registry/repository.

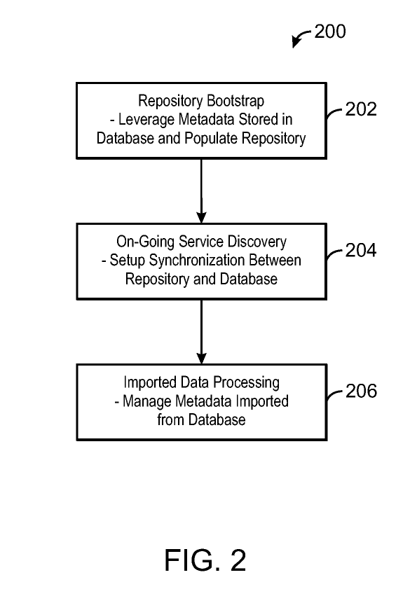

FIG. 2 is a method 200 of maintaining an SOA repository in accordance with an exemplary embodiment of the present invention. In this example, a repository bootstrap [block 202] or an SOA Repository Bootstrap, such as the HP SOA Systinet bootstrap, is defined to leverage service metadata stored in a configuration database, such as a CMDB, and populate to an SOA Repository, with the services and their metadata (for example, by accessing the data from the CMDB). Further, on-going Service Discovery [block 204] may provide for regular synchronization between SOA Repositories and configuration databases such as CMDBs. Thus, Enterprise architects and managers are generally aided in discovering discrepancies between desired and actual state of services. Moreover, rogue services may be identified. In addition, imported data processing [block 206] provides for processes and workflows that facilitate effective management of metadata imported from CMDBs.

In exemplary embodiments of the present invention, SOA Repository data may be automatically compared with the actual state of systems defined and corrections may be made to the data if discrepancies are discovered. Further, in exemplary embodiments, algorithms may be used to facilitate recognition of data from two different domains or models; for example, an SOA Repository and a CMDB. The algorithms may be generic and extensible, and can be applied to customized models, such as with various SOA Repository and various CMDBs. Apart from the algorithms, processes may be implemented that facilitate execution of a larger process effectively and with defined responsibilities. Accordingly, the data in the CMDB may be kept in sync with reality. This may be performed, for example, by HP Universal CMDB. HP Universal CMDB may employ Dynamic & Dependency Mapping (DDM), for example, to automatically provide IT operations with visibility into complex dependencies between applications and the underlying infrastructure to improve service management.

Thus, the SOA Repository content may be automatically synchronized with the actual state of the IT systems, for example, as tracked by a CMDB. For example, in exemplary embodiments, the SOA Repository Bootstrap [block 202] may leverage (or access) service metadata stored in a CMDB and populate a SOA Repository with the services and their metadata. The on-going service discovery [block 204] may set up regular synchronization between SOA Repositories and CMDBs. Enterprise architects and managers may, thus, discover discrepancies between desired and the actual state of services. Moreover, as mentioned, rogue services may be identified. Further, the imported data processing [block 206] may provide processes that allow relatively easy and effective management of metadata imported from CMDBs. The processes may facilitate classification of discovered services and the application of appropriate governance processes to these services;. For example, the discovered services may be classified as: (1) infrastructure, for example, services that are an internal part of third party products; (2) real production, for example, services that are actually in the production state; and (3) rogue processes that should not exist. The benefits of synchronizing design time metadata with the real state of service networks, as well as the discovery of rogue services, may be realized.

A Discovery Administrator, for example, may be a user or role responsible for administration of the discovery process. Further, an Enterprise Manager, for example, may be a user or role responsible for one or more business units, and focused, for example, on providing freshness and consistency of SOA Repository data. In operation, a Discovery Administrator may discover services that have been already registered in a CMDB, and may typically ensure that the services will be appropriately categorized and merged into an SOA Repository. At the end of the discovery process, services should be governed by an appropriate lifecycle process and should be in the correct lifecycle stage. For example, the services should generally fulfill requirements mandated by the newly assigned lifecycle stage and be properly described and maintained in a similar fashion to services initially created in a Service Catalog Thus, the services will be under the control of an SOA Repository service development lifecycle process.

After the import process is completed, newly created Web Services may be divided into groups. Such groups may include infrastructure services, among others. Infrastructure services are services that may be an internal part of third party products, such as a routing service of an Enterprise Service Bus (ESB), among others. These internal services may be identified during the import process and ignored if desired. In certain examples, the internal services may not be documented and their later re-imports may be ignored. The groups may also include real production services, which are services that are generally in the production state (in other words, fully operational and not in development). These services may be used by some consumers or may only be used in support other services. Such production services may be “put under governance” during the import process. For example, they may be categorized as “To Be Governed” services, owned by appropriate owners, assigned to Business Services, and so on. Further, contacts should be specified, processes documented, and service-level objectives (SLOs) defined. In addition, as indicated, rogue services that should not exist may be discovered and removed. Such rogue services may include, for example, processes from an obsolete application or malware, among others.

In on-going service discovery [block 204], an Enterprise Manager may desire to ensure that the “reality check (service discovery)” is performed regularly. The Manager may track which services were newly discovered, and ask the Discovery Administrator to schedule the discovery process so that the process is automatically started at certain time. The discovery process may automatically identify artifacts (SOA Repository Records) and Configuration Items (CIs) that were matched previously. New artifacts and CIs may be matched based on configurable matching algorithm, such as with SOAP Service artifacts being matched with Web Service CIs based on the QName, in other words, the namespace and service name pair in accord with the WSDL specification.

As the number of discovered service can be quite large and there may be several departments responsible for the services, a Discovery Administrator can put discovered services under governance or can delegate that responsibility using the imported data processing [block 206]. In addition, managers may desire to regularly review rogue services, wanting to know which services were marked as “Rogue,” who is responsible for their destruction, and whether they were destroyed. Moreover, it is possible that some services should not be removed in that they are not actually rogue services, but may be, for example, services that were improperly installed or activated. These services may be marked differently, such as “Infrastructure” or “To Be Governed”, and so on, and processed correspondingly. For truly rogue services, it may be determined that the rogue services are not employed by any other processes or users and should be removed. In exemplary embodiments, the destruction may be achieved by assigning an appropriate lifecycle stage to the service, for example, marking the service as retired, which may result in an automatic removal by an SOA system.

In exemplary embodiments, various other algorithms may be employed to assist the SOA management. For example, with a discovery algorithm, data (CIs) may be imported from a CMDB to a SOA Repository. For discovered CIs, a CMDB may be initially queried for the CIs. In embodiments, breadth-first search algorithms can be utilized. A breadth-first search algorithm may begin at the root node(s), for example, and explore neighboring nodes. In general, root node(s) are CIs whose Configuration Item Type (CIT) maps to implementation artifacts, such as SOAP Service, XML, Service, Web Service, etc. For example, the technique may start with Web Service CIs and discover their neighboring CIs, such as hosts, WSDLs, and so on.

With exemplary mapping algorithms, discovered CIs may be converted to artifacts that are listed in the SOA Repository. Further, early matching can occur, for example, using a matching algorithm to determine which CIs can be automatically matched to artifacts in SOA Repository. Thus, in embodiments, if a CI is automatically matched to an artifact (for example, by ID or QName), it may be considered as an already discovered CI and not later processed by the algorithm. Moreover, newly discovered artifacts may be created with security settings (ACLs). These artifacts can be created as “invisible” artifacts. In other words, access may be limited to Administrators, unless they are processed by a later algorithm, such as a final matching algorithm. Thus, following these processes, stored discovered artifacts can be classified as Infrastructure, Rogue, To be Governed, and so forth.

Finally, newly discovered “To be Governed” artifacts may be reconciled with already existing artifacts in the SOA Repository. A matching algorithm may be used to determine potential matches and detect ambiguities. If potential ambiguities are found, users must resolve them manually. When ambiguities are resolved, appropriated lifecycle process and lifecycle stage are selected and artifacts can be governed by this technique. Thereafter, default security settings, such as via access control lists (ACLs), may be applied to artifacts visible to regular SOA Repository users.

In exemplary embodiments, the mapping algorithm may be responsible for conversion of CIs to artifacts. In other words, it may map CMDB model (CITs) to SOA Repository model (artifact types). This algorithm may be general and fully customizable, and, in certain instances, modified by changing only its configuration. It may be configuration processes that determine the mapping of CITs to artifact types (for example, mapArtifact), mapping of links to relations (for example, mapRelation), mapping of CIT properties to artifact type properties (for example, mapProperty), mapping of CIT properties to “virtual properties,” and so on. Virtual properties may be properties not mapped to standard SOA repository properties and could be either properties that are specific to the discovery server or properties which are not directly represented in SOA Repository model, such as in the implementation of integration properties on a bacEntityArtifact platform.

The matching algorithm may be responsible for matching newly discovered artifacts (for example, created from CIs by applying the mapping algorithm) to the artifacts that already exists in the SOA Repository. The matching algorithm may determine which artifacts are new (for example, do not match to anything in the SOA Repository) and which of them can be matched to already existing artifacts in the SOA Repository. If the matching algorithm finds a unique match, users may not have to reconcile the match with SOA Repository content manually. If ambiguities are detected, the potentially duplicate artifacts should be processed manually within the discovery algorithm. Users must determine whether these potential duplicates match to any artifacts in the SOA Repository or are new artifacts. For example, in rare situations, there may be business services in the SOA Repository with the same name. They can differ by version, context, and so forth. If a business service with such a name is discovered in CMDB, it may be problematic to be mapped automatically. Yet, however, the matching algorithm may be general and customizable. The rules may be described in a XML configuration file, for example.

Exemplary embodiments of the present invention may provide a number of advantages. For example, an SOA Repository reality check may provide for semi-automatic or automatic consolidation of a desired state and actual state of systems. Thus, architects and business analyst can generally trust their service catalogs and find discrepancies or inconsistencies. Another advantage is a regular synchronization between an SOA Repository and a CMDB. The on-going discovery may help to ensure that reality checks and data reconciliation occur on regular basis. This technique can be applied to many SOA Repositories and CMDBs, with the technique extensible and customizable in certain instances. Further, the technique may neither necessarily depend on specific models of SOA Repository nor CMDB, with matching and mapping algorithms generic and extensible.

Additional metadata maintained in CMDB, such as on defects, tickets, associated business units, etc., can be considered during data matching or mapping. This metadata may enrich the SOA Repository content and help to establish an accurate context for newly discovered data, which may be beneficial when reconciling newly discovered services (for example, in determining which department should be responsible for governance of a newly discovered service). Further, in exemplary embodiments of the present techniques, defined processes may facilitate effective management of metadata imported from CMDBs. Such embodiments may define activities, flows, and actors that allow discovered data to be sorted and assigned to appropriate users.

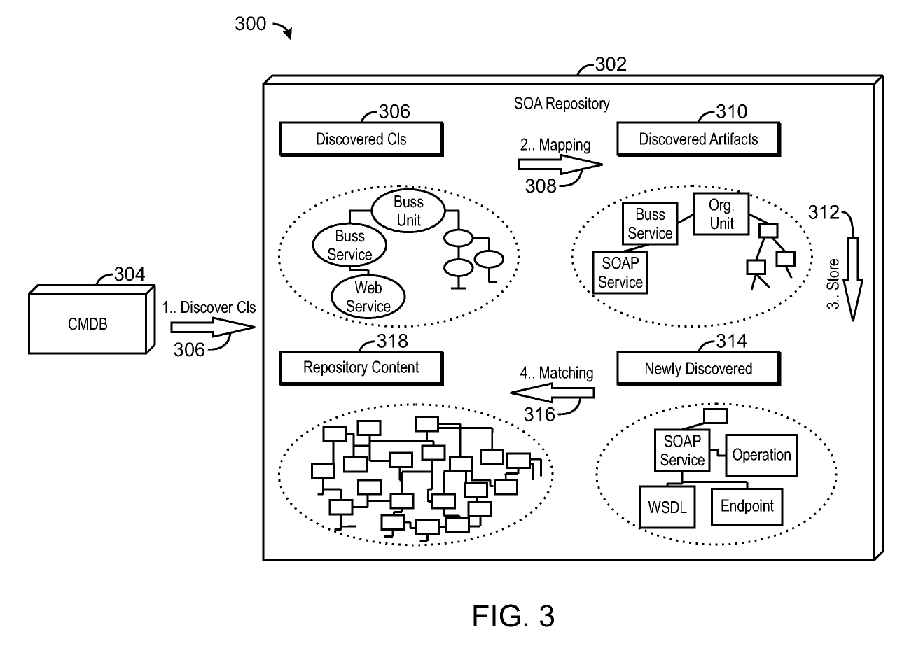

FIG. 3 is a diagrammatical representation 300 of maintaining a repository 302 in accordance with an exemplary embodiment of the present invention. Depicted are an SOA repository 302 and a CMDB 304. In exemplary embodiments, CIs 306 are discovered from the CMDB 304 and sent to the SOA repository 302. The discovered CIs 306 in the repository 302 may be mapped via a mapping algorithm 308 to discovered artifacts 310. Further, the discovered artifacts 310 may be stored 312, for example, as newly discovered artifacts 314. In the illustrated exemplary embodiment, a matching algorithm 316 provides for depositing the discovered artifacts 314 in the repository content 318.

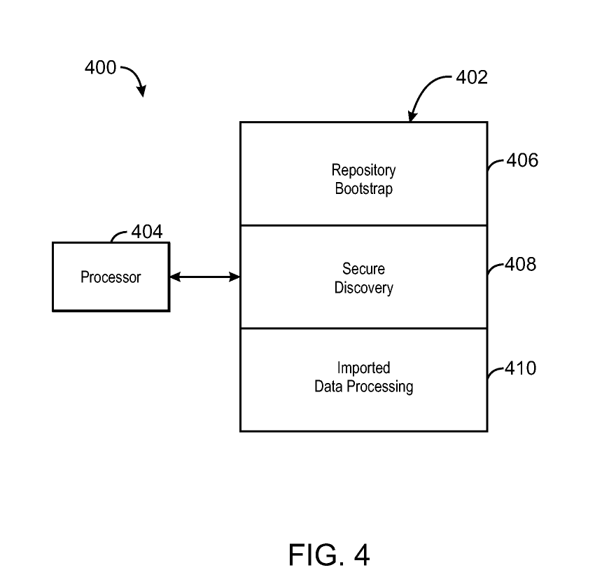

FIG. 4 is a system 400 having memory device(s) 402 coupled with a processor 404, the memory 402 having computer-executable code stored thereon for maintaining a repository via execution of the code (for example, via the processor 404) in accordance with an exemplary embodiment of the present invention. Software modules stored in the memory 402 may include code for exemplary embodiments of the present invention, such as a module 406 for a repository bootstrap, a module 408 for storing associated parameters, and a module 410 for on-going service discovery, as with respect to FIG. 2.

What is claimed is:

1. A method of maintaining a computing services repository, comprising:
accessing service data stored in a configuration database to populate a services repository with services and the service data from the configuration database;
performing on-going service discovery to synchronize the services depository and the configuration database; and
managing service data imported to the services repository from the configuration database.

2. The method of claim 1, wherein the services repository comprises a service-oriented architecture (SOA) repository.

3. The method of claim 1, wherein the configuration database comprises a configuration management database (CMDB).

4. The method of claim 1, wherein the service data comprises service metadata.

5. The method of claim 1, wherein accessing service data comprises applying a services repository bootstrap.

6. The method of claim 1, wherein the on-going service discovery comprises setting up a regular synchronization between the services repository and the configuration database, and wherein managing service data comprises performing imported data processing, wherein performing imported data processing comprises providing processes and workflows that facilitate management of metadata imported to the services repository from the configuration database.

7. The method of claim 6, wherein the imported data processing classifies discovered services as: infrastructure, real production, rogue processes, or any combinations thereof.

8. The method of claim 1, comprising:
discovering discrepancies between desired services and actual state of services in the services repository; and
correcting discrepancies to the data if discrepancies are discovered.

9. The method of claim 1, comprising identifying rogue services.

10. The method of claim 1, comprising:
implementing algorithms that facilitate recognition of the services data of the services repository and of the configuration database.

11. The method of claim 1, comprising:
providing for automatic synchronization of the services repository content with the actual state of the information technology (IT) systems tracked by the configuration database, wherein performing comprises:
discovering services registered in the configuration database; and
categorizing and merging the services into the services repository.

12. The method of claim 1, comprising:
employing mapping algorithms or matching algorithms, or a combination thereof.

13. The method of claim 1, comprising:
harmonizing the service data between the services repository and the configuration database, wherein harmonizing comprises applying auto-discover mechanisms of the configuration database.

14. The method of claim 13, wherein harmonizing comprises applying web standards to facilitate identification of web services automatically.

15. The method of claim 14, wherein the web standards comprise Web Service Definition Language (WSDL).

16. The method of claim 1, comprising:
automatically comparing and updating data of the repository with data tracked by the configuration database.

17. A computer system for maintaining a computing services repository, comprising:
a processor; and
memory having executable code stored therein and configured to:
access service data stored in a configuration database to populate a services repository with services and the service data from the configuration database;
perform on-going service discovery to synchronize the services depository and the configuration database; and
manage service data imported to the services repository from the configuration database.

18. The method of claim 17, wherein the services repository comprises a service-oriented architecture (SOA) repository, and the configuration database comprises a configuration management database (CMDB).

19. A tangible, computer-readable medium, comprising code configured to:
access service data stored in a configuration database to populate a services repository with services and the service data from the configuration database;
perform on-going service discovery to synchronize the services depository and the configuration database; and
manage service data imported to the services repository from the configuration database.

20. The method of claim 19, wherein the services repository comprises a service-oriented architecture (SOA) repository, and the configuration database comprises a configuration management database (CMDB).
